(19) United States
(12) Patent Application Publication
(10) Pub. No.: US 2026/0157426 A1
(43) Pub. Date: Jun. 11, 2026

(54) INDUCTIVELY HEATED SUBSTRATE

(71) Applicant: Altria Client Services LLC, Richmond, VA (US)

(72) Inventors: Shaoyong YU, Glen Allen, VA (US); Shuzhong ZHUANG, Glen Allen, VA (US); Raymond W. LAU, Glen Allen, VA (US); Eric HAWES, Midlothian, VA (US)

(73) Assignee: Altria Client Services LLC, Richmond, VA (US)

(21) Appl. No.: 19/413,295

(22) Filed: Dec. 9, 2025

Related U.S. Application Data
(60) Provisional application No. 63/730,007, filed on Dec. 10, 2024.

(51) Int. Cl. A24D 1/20; A24D 1/00; A24D 3/17; A24D 3/18; A24F 40/20; A24F 40/465; H05B 6/10

(52) U.S. Cl. CPC A24D 1/20; A24D 1/002; A24D 3/17; A24D 3/18; A24F 40/20; A24F 40/465; H05B 6/108

(57) ABSTRACT

A cartridge for an aerosol-generating article includes an inductive substrate material including an aerosol-generating substrate and at least one susceptor. The susceptors are configured to heat at least a portion of the aerosol-generating substrate.

### CROSS-REFERENCE TO RELATED APPLICATIONS

This application claims the benefit of U.S. Provisional Application No. 63/730,007 filed on Dec. 10, 2024, the entire disclosure of which is incorporated herein by reference in its entirety.

### BACKGROUND

### Field

The present disclosure relates to inductively heated substrates for a heated tobacco device.

### SUMMARY

At least one example embodiment relates to a cartridge for use in a heated tobacco device. In at least one example embodiment, the cartridge comprises an aerosol-generating substrate and a plurality of susceptors within the aerosol-generating substrate. The plurality of susceptors are configured to heat at least a portion of the aerosol-generating substrate.

In at least one example embodiment, the cartridge further comprises a housing surrounding the aerosol-generating substrate. The housing is formed of one or more material including a paper, tobacco, non-tobacco cellulose, a fabric, a metal, a polymer, or any combination thereof. In at least one example embodiment, the housing includes non-tobacco cellulose and the housing is impregnated with at least one flavorant. In at least one example embodiment, the housing includes non-tobacco cellulose and the housing is impregnated with nicotine.

In at least one example embodiment, the aerosol-generating substrate includes a carrier material, the carrier material including a plant material. In at least one example embodiment, the plant material includes tobacco. In at least one example embodiment, the plant material includes non-tobacco cellulose. In at least one example embodiment, the plant material includes hemp. In at least one example embodiment, the plant material includes reconstituted tobacco.

In at least one example embodiment, the aerosol-generating substrate comprises a carrier material; a plurality of aerosol-generating agents within the carrier material; and a plurality of flavoring agents within carrier material. The plurality of flavoring agents includes a botanical material, a gel, a film, flavor bits, a powder, a compressed powder, a flavor bead, microcapsules, capsules, or any combination thereof.

In at least one example embodiment, the cartridge further comprises a first filter at a first end of the aerosol-generating substrate; and a second filter at a second end of the aerosol-generating substrate.

In at least one example embodiment, the cartridge further comprises a mouthpiece at a first end of the aerosol-generating substrate.

In at least one example embodiment, a density of the plurality of susceptors within the aerosol-generating substrate is between 1.5 g/cm³ and 10 g/cm³.

In at least one example embodiment, the plurality of susceptors includes a circular shape, an oval shape, a rectangular shape, a polygonal shape, or any combination thereof.

In at least one example embodiment, the plurality of susceptors is uniformly disposed throughout the aerosol-generating substrate.

In at least one example embodiment, the plurality of susceptors is non-uniformly disposed throughout the aerosol-generating substrate. The plurality of susceptors is arranged in a plurality of rows and columns within the aerosol-generating substrate. In at least one example embodiment, the plurality of susceptors includes a plurality of elongate rods. In at least one example embodiment, the plurality of susceptors comprises a material including iron, steel, stainless steel, graphite, graphene, carbon fiber, aluminum brass, copper, chrome, nickel, tungsten, silver, gold, platinum, silicon, or any combination thereof. In at least one example embodiment, a density of the plurality of susceptors in the cartridge is greater at a central portion of the aerosol-generating substrate than at edges of the aerosol-generating substrate.

At least one example embodiment relates to a heated tobacco system. In at least one example embodiment, the heated tobacco system comprises a cartridge and a heated tobacco device. In at least one example embodiment, the cartridge includes an aerosol-generating substrate, and a plurality of susceptors within the aerosol-generating substrate. The plurality of susceptors are configured to heat at least a portion of the aerosol-generating substrate. In at least one example embodiment, the heated tobacco device includes a device housing defining a cavity configured to receive at least a portion of the cartridge, an induction source within the device housing, and a power supply configured to supply power to the induction source.

In at least one example embodiment, the aerosol-generating substrate comprises: a carrier material; a plurality of aerosol-generating agents within the carrier material; and a plurality of flavoring agents within the aerosol-generating substrate.

In at least one example embodiment, the heated tobacco system further comprises a first filter at a first end of the aerosol-generating substrate; and a second filter at a second end of the aerosol-generating substrate.

In at least one example embodiment, the heated tobacco system further comprises a mouthpiece at a first end of the aerosol-generating substrate.

In at least one example embodiment, a density of the plurality of susceptors within the aerosol-generating substrate is between 1.5 g/cm³ and 10 g/cm³. In at least one example embodiment, the plurality of susceptors include a circular shape, a rectangular shape, a polygonal shape, or combination thereof. In at least one example embodiment, the plurality of susceptors is uniformly disposed throughout the aerosol-generating substrate. In at least one example embodiment, the plurality of susceptors is arranged in a plurality of rows and columns within the aerosol-generating substrate. In at least one example embodiment, the plurality of susceptors include a plurality of elongate rods. In at least one example embodiment, a density of the plurality of susceptors in the cartridge is greater at a central portion of the aerosol-generating substrate than at edges of the aerosol-generating substrate.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is a front perspective view of a heated tobacco device in accordance with at least one example embodiment.

FIG. 1B is a rear perspective view of the heated tobacco device of FIG. 1 in accordance with at least one example embodiment.

FIG. 1C is a front view of the heated tobacco device of FIG. 1 in accordance with at least one example embodiment.

FIG. 2 is a schematic view of a heated tobacco device according to at least one example embodiment.

FIG. 3 is an illustration of an inductive substrate for use in the heated tobacco devices of FIGS. 1A-1C and 2 according to at least one example embodiment.

FIG. 4 is an illustration of a cartridge including the inductive substrate of FIG. 3 and having a rod shape and a wrapper in a partially unwrapped condition according to at least one example embodiment.

FIG. 5 is an illustration of a cartridge including the inductive substrate of FIG. 3 according to at least one example embodiment.

FIG. 6 is an illustration of a cartridge including the inductive substrate of FIG. 3 according to at least one example embodiment.

FIG. 7 is an illustration of a cartridge including the inductive substrate of FIG. 3 according to at least one example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” “attached to,” “adjacent to,” or “covering” another element or layer, it may be directly on, connected to, coupled to, attached to, adjacent to or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

While the term “same” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

The controller may include processing circuitry such as hardware including logic circuits; a hardware/software combination such as a processor executing software stored in a memory; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Some electronic devices are configured to heat a material (e.g., plant material) to a temperature that is sufficient to release constituents of the material while keeping the temperature below its ignition temperature so as to avoid a self-sustaining burning or a self-sustaining combustion of the material (i.e., in contrast to where a material is lit, such as lit-end cigarettes). Such devices may be characterized as generating an aerosol of constituents released by heating, and may be referred to as heated tobacco devices.

It is understood that heating of a material below its ignition temperature may, in some circumstances, produce incidental and insubstantial levels of oxidized or other thermal decomposition byproducts. However, in some embodiments, the heating in heated tobacco devices is below the pyrolysis temperature of the material so as to produce an aerosol having no or insubstantial levels of thermal decomposition byproducts of the material. Thus, in an example embodiment, pyrolysis of the material does not occur during the heating and resulting production of aerosol. In other instances, there may be incidental pyrolysis, with production of oxidized or other thermal decomposition byproducts at levels that are insignificant relative to the primary constituents released by heating of the material.

As discussed herein, an aerosol-forming substrate is a material or combination of materials that may yield an aerosol. An aerosol relates to the matter generated or output by the devices disclosed, claimed, and equivalents thereof. The material may include a compound (e.g., nicotine, cannabinoid, cannabimimetic agent) that is released when the material is heated. In such an instance, an aerosol including the compound is produced when the material is heated. The heating may be below the ignition temperature so as to avoid a self-sustaining burning or a self-sustaining combustion of the material (i.e., in contrast to where a material is lit, such as lit-end cigarettes). It is understood that heating of a material below its ignition temperature may, in some circumstances, produce incidental and insubstantial levels of oxidized or other thermal decomposition byproducts. However, in some embodiments, the heating in heated tobacco devices is below the pyrolysis temperature of the material so as to produce an aerosol having no or insubstantial levels of thermal decomposition byproducts of the material. Thus, in an example embodiment, pyrolysis of the material does not occur during the heating and resulting production of aerosol. In other instances, there may be incidental pyrolysis, with production of oxidized or other thermal decomposition byproducts at levels that are insignificant relative to the primary constituents released by heating of the material.

The material(s) of the aerosol-forming substrate may include a fibrous material. For instance, the fibrous material may be a botanical material. The fibrous material is configured to release a compound when heated. The compound may be a naturally occurring constituent of the fibrous material. For instance, the fibrous material may be plant material such as tobacco, and the compound released may be nicotine. The term “tobacco” includes any tobacco plant material including tobacco leaf, tobacco plug, reconstituted tobacco, compressed tobacco, shaped tobacco, or powder tobacco, and combinations thereof from one or more species of tobacco plants, such as Nicotiana rustica and Nicotiana tabacum.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

The compound in the generated aerosol may also be a naturally occurring constituent of a medicinal plant that has a medically-accepted physiological effect (e.g., therapeutic effect, prophylactic effect). For instance, the medicinal plant may be a cannabis plant or a cannabimimetic plant (i.e., a plant with similar pharmacological effects to those of cannabis). For a cannabis plant, the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). The fibrous material may include the leaf and/or flower material from one or more species of cannabis plants such as Cannabis sativa, Cannabis indica, and Cannabis ruderalis. In some instances, the fibrous material is a mixture of 60-80% (e.g., 70%) Cannabis sativa and 20-40% (e.g., 30%) Cannabis indica. For a cannabimimetic plant, the compound may be a cannabimimetic agent. Cannabimimetic agents interact with receptors in the body to produce similar pharmacological effects as cannabinoids.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) is a precursor of tetrahydrocannabinol (THC), while cannabidiolic acid (CBDA) is precursor of cannabidiol (CBD). Tetrahydrocannabinolic acid (THCA) and cannabidiolic acid (CBDA) may be converted to tetrahydrocannabinol (THC) and cannabidiol (CBD), respectively, via heating. In an example embodiment, heat from a heater (e.g., of the heating assembly 340 shown in FIG. 8) may cause decarboxylation so as to convert the tetrahydrocannabinolic acid (THCA) to tetrahydrocannabinol (THC), and/or to convert the cannabidiolic acid (CBDA) to cannabidiol (CBD).

In instances where both tetrahydrocannabinolic acid (THCA) and tetrahydrocannabinol (THC) are present, the decarboxylation and resulting conversion will cause a decrease in tetrahydrocannabinolic acid (THCA) and an increase in tetrahydrocannabinol (THC). At least 50% (e.g., at least 87%) of the tetrahydrocannabinolic acid (THCA) may be converted to tetrahydrocannabinol (THC) during the heating. Similarly, in instances where both cannabidiolic acid (CBDA) and cannabidiol (CBD) are present, the decarboxylation and resulting conversion will cause a decrease in cannabidiolic acid (CBDA) and an increase in cannabidiol (CBD). At least 50% (e.g., at least 87%) of the cannabidiolic acid (CBDA) may be converted to cannabidiol (CBD) during the heating.

Furthermore, the compound which is released may be or may additionally include a non-naturally occurring additive that is subsequently introduced into the fibrous material. In one instance, the fibrous material may include at least one of cotton, polyethylene, polyester, rayon, combinations thereof, or the like (e.g., in a form of a gauze). In another instance, the fibrous material may be a cellulose material (e.g., non-tobacco and/or non-cannabis material). In either instance, the compound introduced may include nicotine, cannabinoids, cannabimimetic agents, and/or flavorants. The flavorants may be from natural sources, such as plant extracts (e.g., tobacco extract, cannabis extract, cannabimimetic extract), and/or artificial sources. In yet another instance, when the fibrous material includes tobacco and/or cannabis, the compound may be or may additionally include one or more flavorants (e.g., menthol, mint, vanilla). Thus, the compound within the aerosol-forming substrate may include naturally occurring constituents and/or non-naturally occurring additives. In this regard, it should be understood that existing levels of the naturally occurring constituents of the aerosol-forming substrate may be increased through supplementation. For example, the existing levels of nicotine in a quantity of tobacco may be increased through supplementation with an extract containing nicotine. Similarly, the existing levels of one or more cannabinoids in a quantity of cannabis may be increased through supplementation with an extract containing such cannabinoids. Likewise, the existing levels of one or more cannabimimetic agents in a quantity of cannabimimetic material may be increased through supplementation with an extract containing such cannabimimetic agents.

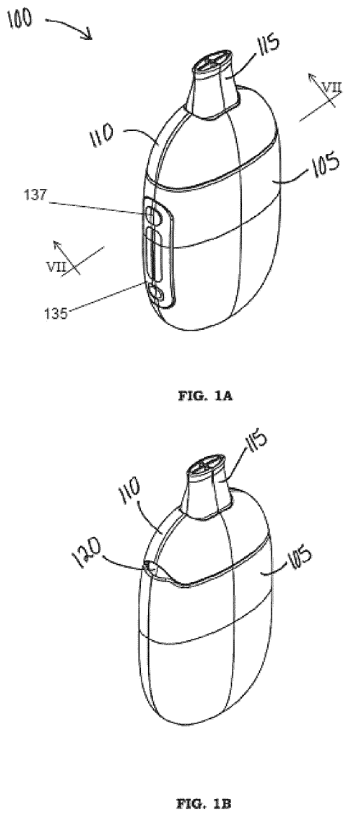

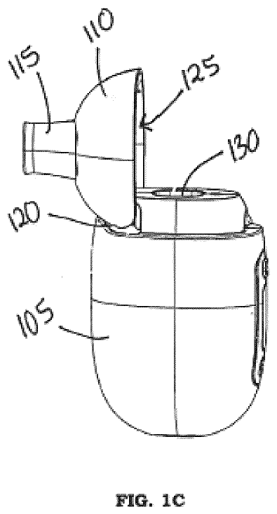

FIG. 1A is a front perspective view of a heated tobacco device in accordance with at least one example embodiment. FIG. 1B is a rear perspective view of the heated tobacco device of FIG. 1 in accordance with at least one example embodiment. FIG. 1C is a front view of the heated tobacco device of FIG. 1 in accordance with at least one example embodiment.

At least one example embodiment relates to a heated tobacco device 100 including a housing 105 and a lid 110 coupled to the housing. In at least one example embodiment, the lid 110 may also include a mouthpiece 115 extending from at least a portion of the lid 110. In at least one example embodiment, the lid 110 may be removably coupled to the housing 105. For example, the lid 110 may be coupled to the housing by a hinge 120. The lid may be configured to move between a closed position, shown in FIGS. 1A-1B, and an open position, shown in FIG. 1C, at the hinge 120.

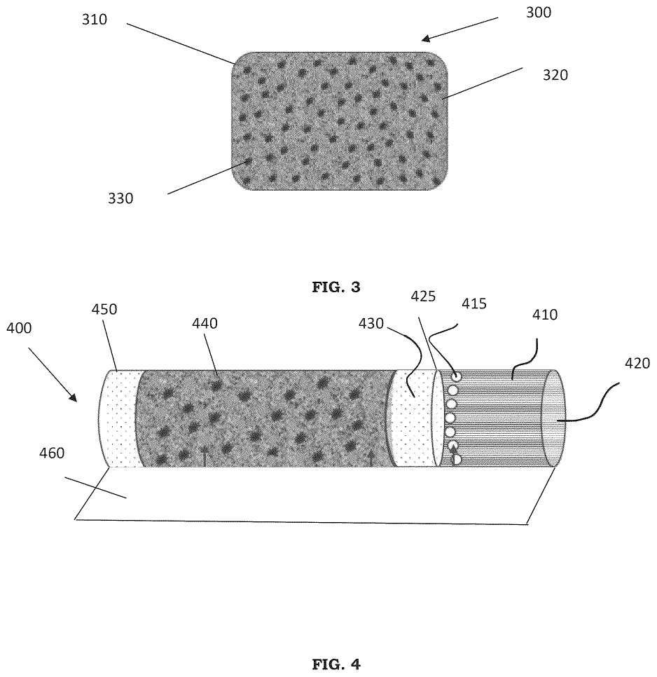

In at least one example embodiment, the housing 105 may include a capsule (or cartridge) receiving cavity 130 configured to receive a capsule (or cartridge). The capsule may be configured to contain an aerosol-forming substrate that is heated by a heater in the housing 105. The heater may be an inductive heater. The aerosol-forming substrate may include the inductive substrate as further described herein with respect to FIG. 3.

In at least one example embodiment, the device and capsule may include features as set forth in application Ser. No.: 17/151,327, filed on Jan. 18, 2021, which published as US 2022/0225672, and application Ser. No.: 17/947,436, filed on Sep. 19, 2022, the entire contents of each of which are incorporated herein by reference thereto.

In at least one example embodiment, the device includes a battery (not shown) configured to supply power to the heater. It should be understood that the shape of the battery (or batteries) for the power supply may vary. For example, the battery may be cylindrical, prismatic, disc-shaped, a pouch battery, or any other variation of battery shape known in the art. Additionally, it should be understood that the battery may be any of a variety of types. For example, in one embodiment, the battery may be a rechargeable battery (e.g., lithium-ion). In another embodiment, the battery may be a non-rechargeable battery (e.g., alkaline). In yet another embodiment, the battery may include silver oxide, carbon zinc, cadmium, nickel, or any another material known in the art. Furthermore, the battery may include a primary cell and/or a secondary cell. It will be understood by those of ordinary skill in the art that various changes in form and details of the battery may be made without departing from the spirit and the scope of the invention.

In at least one example embodiment, the heated tobacco device 100 is configured to heat a capsule, including the inductive substrate, inserted into the capsule receiving cavity 130 to generate an aerosol. The heated tobacco device 100 and method of generating an aerosol may be similar or analogous to the device and methods as also set forth in application Ser. No. 17/947,436, published as US 2024/0090574, and filed on Sep. 19, 2022, the entire contents of which is incorporated herein by reference thereto.

In at least one example embodiment, a method of generating an aerosol may include initially loading the capsule into the heated tobacco device 100. To load the capsule 200, the lid 110 is pivoted to the open position, shown in FIG. 1C, and the capsule is inserted into the capsule-receiving cavity 130. Next, the lid 110 is pivoted to the closed position, shown in FIGS. 1A-1B.

In at least one example embodiment, the heated tobacco device 100 may be activated using an interface panel 135, such as by pressing a power button 137, or upon detection of a draw event. For example, the heated tobacco device 100 may include a flow sensor configured to detect a draw event or a puff. Upon activation, a heater is configured to heat the capsule within the capsule receiving cavity 130. For example, the heated tobacco device may include control circuitry configured to instruct a power source within the housing 105 to supply an electrical current from a power supply to a heater within the housing 105. In at least one example embodiment, the capsule may undergo inductive heating. The device may include an inductive heating element (e.g., coil). In use, electric currents are induced in the susceptors in the inductive substrate when inductively heated so as to generate heat. The heat generating susceptors then in turn heat the aerosol-forming agents to generate aerosol.

In at least one example embodiment, the heating of the aerosol-forming substrate within the capsule may be below a combustion temperature of the aerosol-forming substrate so as to produce an aerosol without involving a substantial pyrolysis of the aerosol-forming substrate or the substantial generation of combustion byproducts (if any). Thus, in at least one example embodiment, pyrolysis does not occur during the heating and resulting production of aerosol. In other instances, there may be some pyrolysis and combustion byproducts, but the extent may be considered relatively minor and/or merely incidental. The method of heating/control may be as described in U.S. application Ser. No. 17/151,375, published as US 2022/0225685 and titled “Heat-Not-Burn (HNB) Aerosol-Generating Devices Including Energy Based Heater Control, And Methods Of Controlling A Heater”, filed Jan. 18, 2021; and U.S. application Ser. No. 17/151,409, issued as U.S. Pat. No. 11,789,476 and titled “Heat-Not-Burn (HNB) Aerosol-Generating Devices Including Intra-Draw Heater Control, and Methods of Controlling a Heater”, filed Jan. 18, 2021, the entire contents of each of which are incorporated herein by reference thereto.

In at least one example embodiment, the device may have any additional or alternative features as set forth in U.S. Pat. No.: 9,901,117 to Levitz et al., filed Feb. 12, 2024, U.S. Pat. No.: 9,888,719 to Cadieux et al., filed Feb. 27, 2015, U.S. Pat. No.: 11,576,424 to Courbat et al., filed Apr. 5, 2018, the entire contents of each of which are incorporated herein by reference thereto.

Upon a draw or application of negative pressure to the heated tobacco device 100, such as via the mouthpiece 115, ambient air is drawn into the heated tobacco device 100. Once inside, the air flows through at least one air channel within the housing 105 and through the capsule within the capsule receiving cavity 130. The airflow travels through the capsule and through the aerosol-forming substrate within the capsule so as to entrain the volatiles released by the aerosol-forming substrate, which results in an aerosol. The resulting air exits the capsule and exits the heated tobacco device 100 through the mouthpiece 115.

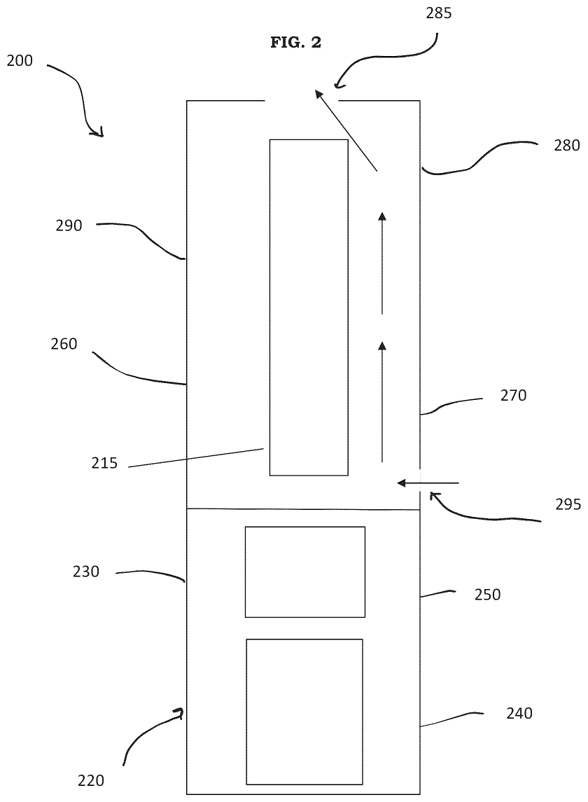

FIG. 2 is a schematic view of another heated tobacco device according to at least one example embodiment.

In at least one example embodiment, as shown in FIG. 2, a heated tobacco device 200 includes a mouthpiece portion 280 and a battery section 220. The heated tobacco device 200 comprises a main body housing 230 which contains a power supply 240 and an electric control circuitry 250. The main body housing 230 defines a cavity 260 in which a cartridge 270 is received. The device 200 may also include a mouthpiece portion 280 comprising an outlet 285. A housing 290 of the mouthpiece portion 280 and the main body housing 230 together form the housing of the device 200. The mouthpiece portion 280 may be connected to the main body by any kind of connection, such as by a hinged connection, a snap fitting, or a screw fitting. Air inlets 295 are defined in the housing 290 or the main body housing 230. In other example embodiments, the mouthpiece portion 280 and the battery portion 220 may be a single, unitary piece having a single housing.

In at least one example embodiment, as shown in FIG. 2, the heated tobacco device 200 includes an induction source, such as an induction coil 215 is arranged within the cavity 260. The coil 215 is operatively connected to the control circuitry 240. The coil 215 may be positioned close to an inner surface of the cavity 260, opposite to an end surface of the cartridge 270, at the level of the air inlets 295. Thus, air drawn through the inlets 295 towards to the outlet 285 passes through a passageway formed between the coil 215 and the end surface of the cartridge 270.

In at least one example embodiment, the cartridge 270 may have a generally circular, oval, rectangular, polygonal, or cylindrical shape as will be further discussed with respect to FIGS. 3-7.

When the cartridge 270 is received in the cavity 260, susceptors (described with respect to FIG. 3-7) may be positioned within the cartridge 270 and/or adjacent the coil 215.

During vaping, an adult consumer may puff on the mouthpiece portion 280 to draw air though the air inlets 295 into the cavity 260 and the mouthpiece portion 280 and out of the outlet 285. The device 200 may include a sensor, such as a puff sensor, which may be part of the control circuitry 104. The puff sensor may be arranged within the cavity close to the air inlets 122. When a puff is detected, the electric circuitry 240 provides a high frequency oscillating current to the coil 215. This generates an oscillating magnetic field which passes through the susceptor (shown in FIGS. 3-7). As a consequence, the susceptor heats up due to hysteresis losses and reaches a temperature sufficient to vaporize the aerosol-forming substrates in the inductive substrate as described herein.

FIG. 3 is an illustration of an inductive substrate for use in the heated tobacco devices of FIGS. 1A-1C and 2 according to at least one example embodiment.

In at least one example embodiment, as shown in FIG. 3, an inductive substrate 300 for use in a cartridge, as described herein, includes a carrier material 310, an aerosol-forming material 320, and at least one susceptor 330.

In at least one example embodiment, the aerosol-forming material 320 includes glycerin, propylene glycol, or any combination thereof. The aerosol-forming material 320 may be included in an amount ranging from about 1 wt % to about 70 wt % based on a weight of the inductive substrate (e.g., about 5 wt % to about 65 wt %, about 10 wt % to about 60 wt %, about 15 wt % to about 55 wt %, about 20 wt % to about 50 wt %, about 25 wt % to about 45 wt %, or about 30 wt % to about 40 wt %).

In at least one example embodiment, the carrier material 310 may include plant material. The plant material may include tobacco, non-tobacco cellulose, reconstituted tobacco, hemp, cannabis, or any other suitable carrier material. Each cartridge may include about 10 mg to about 2 g of the carrier material 310 (e.g., about 50 mg to about 1.5 g or about 1 g to about 1.25 g).

In at least one example embodiment, the carrier material 310 may be impregnated with at least one additive. The additive may include an active ingredient, a flavorant, a sensate, an energizing ingredient, or any combination thereof.

In at least one example embodiment, the active ingredient comprises nicotine. The nicotine may be tobacco-derived nicotine or synthetic nicotine. The nicotine may be included in an amount ranging from about 0.5 mg to about 40 mg (e.g., about 10 mg to about 35 mg, about 15 mg to about 35 mg, or about 20 mg to about 25 mg).

In at least one example embodiment, the flavorant may include a botanical material, a gel, a film, flavor bits, a powder, a compressed powder, a flavor bead, microcapsules, capsules, or any combination thereof. In at least one example embodiment, the inductive substrate includes an encapsulated flavorant. The flavorant may be natural or artificial. The flavorant may include, for example, a fruit flavorant (e.g., bergamot, berry, cherry, lemon, and/or orange), a liquor or liqueur flavorant (e.g., bourbon, cognac, scotch, whiskey, and/or DRAMBUIE brand liqueur), a mint flavorant (e.g., Japanese mint, menthol, peppermint, spearmint, wintergreen, and/or mint oils from a species of the genus Mentha), a floral flavorant (e.g., geranium, lavender, and/or rose), a spice, an herb, or another botanical or botanical-derived flavorant (e.g., anise, apium graveolens, caraway, cardamom, cascarilla, cassia, cinnamon, chamomile, clove, cocoa, coffee, coriander, fennel, ginger, jasmine, licorice, nutmeg, pimenta, sage, sandalwood vanilla, and/or ylang-ylang), honey essence, or any combination thereof. In at least one example embodiment, the flavorant includes bergamot, berry, cherry, lemon, orange, bourbon, cognac, scotch, whiskey, DRAMBUIE brand liqueur, Japanese mint, menthol, peppermint, spearmint, wintergreen, mint oils from a species of the genus Mentha, geranium, lavender, rose, anise, apium graveolens, caraway, cardamom, cascarilla, cassia, cinnamon, chamomile, clove, coffee, coriander, fennel, ginger, jasmine, licorice, nutmeg, pimenta, sage, sandalwood vanilla, ylang-ylang, honey essence, or any combination thereof. The flavorant may be included in an amount ranging from about 0.01 wt % to about 30 wt % based on a weight of the inductive substrate (e.g., about 1 wt % to about 25 wt %, about 5 wt % to about 20 wt %, or about 10 wt % to about 15 wt %).

In at least one example embodiment, the sensate may comprise a soothing ingredient, a cooling ingredient, a warming ingredient, or any combination thereof. The at least one example embodiment, the sensate or chemesthesis agent may include mint, menthol, cinnamon, pepper, jambu, or any combination thereof. In at least one example embodiment, the soothing agent includes theanine, melatonin, or both theanine and melatonin. The soothing agent may also include, for example only, chamomile, lavender, jasmine, soursop, cannabidiol, or any combination thereof. The soothing agent can be added as a flavorant and or aroma. The sensate may be included in an amount ranging from about 0.01 wt % to about 10 wt % based on a weight of the inductive substrate (e.g., about 1 wt % to about 8 wt % or about 2 wt % to about 5 wt %).

For example, in some example embodiments, the at least one sensate or chemesthesis agent may include capsaicin, pipeline, alpha-hydroxy-sanshool, and (8)-gingerole, which may be selected so as to provide a warm, tingling or burning sensation. In other example embodiments, the at least one sensate or chemesthesis agent may include menthol, menthyl lactate, WS-3 (N-Ethyl-p menthane-3-carboxamide), WS-23 (2-Isopropyl-N,2,3-trimethylbutyramide) and Evercool 180™ (available from Givaudan SA), which may be selected so as to provide a cooling sensation.

In at least one example embodiment, the at least one susceptor 320 is formed of iron, steel, stainless steel, graphite, graphene, carbon fiber, aluminum, brass, copper, chrome, nickel, tungsten, silver, gold, platinum, silicon, and alloys containing one or more of these materials. Each of the at least one susceptors 320 may have dimensions ranging from about 0.02 mm to about 60 mm (e.g., about 1 mm to about 55 mm, about 5 mm to about 50 mm, about 10 mm to about 45 mm, about 15 mm to about 40 mm, or about 20 mm to about 35 mm). In at least one example embodiment, the susceptors 320 should be small enough such that about 1 to 100 susceptors can be distributed in the carrier materials. In at least one example embodiment, a smaller number of susceptors 320 are included where the susceptors 320 have larger dimensions and a larger number may be included where the susceptors are smaller.

In at least one example embodiment, the susceptors 320 are uniformly distributed throughout the inductive substrate 300. In other example embodiments, the susceptors 320 are non-uniformly and/or are randomly distributed throughout the inductive substrate 300. It should be noted that the number and pattern of susceptors 320 may vary or may be the same from cartridge to cartridge formed of the inductive substrate material.

In at least one example embodiment, a single cartridge may include susceptors having a same size or susceptors having different sizes. In at least one example embodiment, a density of the plurality of susceptors within the aerosol-generating substrate is between 1.5 g/cm³ and 10 g/cm³.

In at least one example embodiment, the susceptors may have a circular shape, a rectangular shape, a polygonal shape, or any combination thereof. The shape of the susceptors in a single cartridge may be the same or different. That is, a single cartridge may include both round and square susceptors, for example.

In at least one example embodiment, the susceptors 320, the aerosol-forming substrate, and carrier materials can be simply mixed to make the inductive substrate 300. Susceptors and carrier materials can also be mixed first then aerosol formers are added into them. Aerosol formers can also be added into the carrier materials first, then mixed with susceptors. Susceptors can also be coated with the aerosol formers with or without some necessary extra materials, then mix with the carrier materials. The susceptors should be dispersed into the carrier materials so that the susceptors are not collected into large clusters. The susceptors can be buried into the powdery carrier materials or be fixed into the bulk carrier materials.

Susceptors are required to be dispersed into the carrier materials so that they are not collected into large clusters. Susceptors can be buried into the powdery carrier materials, or be fixed into the bulk carrier materials, or the combination of the two.

FIG. 4 is an illustration of a cartridge including the inductive substrate of FIG. 3 and having a rod shape and a wrapper in a partially unwrapped condition according to at least one example embodiment.

In at least one example embodiment, a cartridge 400 for use in the heated tobacco device of FIG. 2, for example. In at least one example embodiment, the cartridge 400 may be in the form of a rod or cylinder. The cartridge 400 extends in a longitudinal direction and has a length of about 25 mm to about 100 mm (e.g., about 30 mm to about 95 mm, about 35 mm to about 90 mm, about 40 mm to about 85 mm, about 45 mm to about 80 mm, about 50 mm to about 75 mm, or about 55 mm to about 70 mm). The rod or cylinder may have a diameter ranging from about 4 mm to about 10 mm (e.g., about 5 mm to about 9 mm, or about 6 mm to about 8 mm).

In at least one example embodiment, the cartridge 400 includes a mouthpiece 410 or filter which may extend from the cavity 260, such that an adult consumer may directly engage the mouthpiece 410. The mouthpiece 410 or filter may be formed of cellulose acetate, polylactic acid, nylon or any combination thereof.

In at least one example embodiment, the mouthpiece 410 may include one or more ventilation holes 415 extending through a sidewall of the mouthpiece 410. The ventilation holes may have diameters ranging from about 0.05 mm to about 0.5 mm. The size and number of ventilation holes may be chosen to provide sufficient ventilation and resistance-to-draw (RTD). For example, a desired RTD may range from about 30 mm water column to about 150 mm water column. For example, the mouthpiece may include 1 to 50 ventilation holes arranged about 10 mm to 30 mm from the mouth-end of the mouthpiece.

In at least one example embodiment, the mouthpiece has a mouth end (or first end) 420 and a second end 425 that is opposite the mouth end. The ventilation holes 415 may be adjacent a first seal 430. For example, the ventilation holes 415 may be positioned about 1 mm to about 30 mm from the first seal 430.

In at least one example embodiment, a plug or section 440 of inductive substrate material, as described with respect to FIG. 3, is between the first seal 430 and a second seal 450. In at least one example embodiment, the first seal 430 and the second seal 450 are filters. The first seal 430 and the second seal 450 may be about 0.1 mm to about 10 mm in length and may be formed of cellulose acetate, cellulosic materials, nylon nonwoven cloth, perorated aluminum foil, or any combination thereof. The first seal 430 and the second seal 450 may act to prevent the inductive substrate material from falling out of the cartridge 400.

In at least one example embodiment, as shown in FIG. 4, which is a partially unwrapped view of the cartridge 400, the cartridge includes a housing 460 in the form of a wrapper that surrounds the mouthpiece 410, the first seal 430, the plug 440 of inductive substrate material and the second seal 450 to maintain the cartridge 400 in a generally cylindrical shape. The housing 460 may be formed of tobacco leaf, reconstituted tobacco, hemp, non-tobacco plant material, or a wrapping paper such as the paper used to wrap cigarettes. In some example embodiments, the housing 460 may include aluminum film therein to reduce and/or prevent being wetted by glycerol in the inductive substrate.

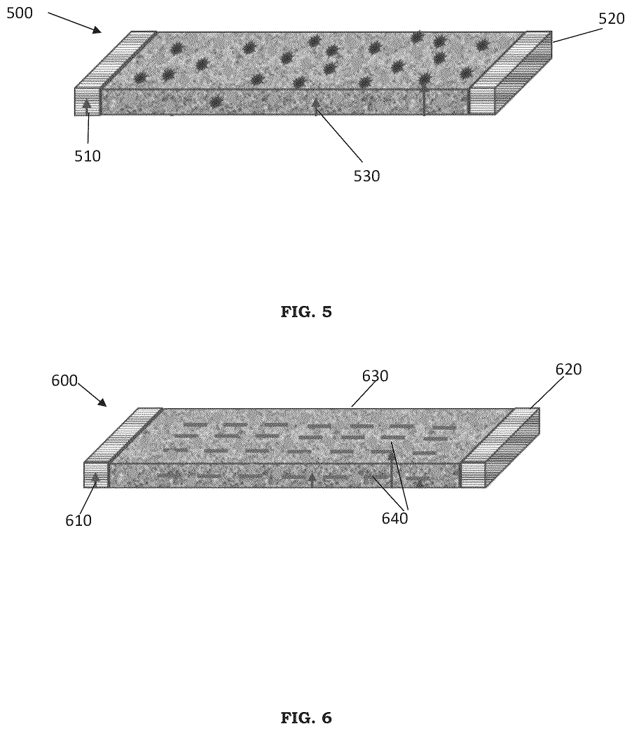

FIG. 5 is an illustration of a cartridge including the inductive substrate of FIG. 3 according to at least one example embodiment.

In at least one example embodiment, as shown in FIG. 5, a cartridge 500 is generally the same as the cartridge of FIG. 4, except that the cartridge 500 excludes the mouthpiece 410 and is generally rectangular in shape. In at least one example embodiment, the cartridge 500 has a length ranging from about 5 mm to about 60 mm, a width ranging from about 5 mm to about 30 mm, and a thickness ranging from about 2 mm to about 10 mm. The cartridge 500 may be sized and configured to be received, for example, in the capsule receiving cavity of the device 100 of FIGS. 1A-1C as described herein.

In at least one example embodiment, the cartridge 500 includes a first seal 510, a second seal 520, and a plug 530 of the inductive substrate material of FIG. 3. The first seal 510 and the second seal 520 may be generally the same as the first and second seals of the cartridge 400 of FIG. 4. In at least one example embodiment, the first seal 510 and the second seal 520 are filters.

In at least one example embodiment, the cartridge 500 may include a housing (not shown), such as a wrapper as described with respect to FIG. 4. In other example embodiments, in lieu of being formed of paper, tobacco, or non-tobacco cellulose, the housing may be formed of a fabric, a metal, a polymer, or any combination thereof. In still other example embodiments, the housing may be a capsule or cartridge.

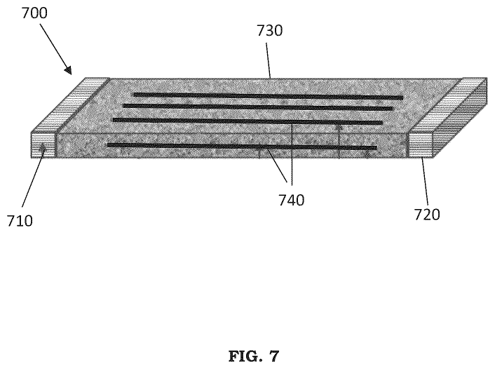

FIG. 6 is an illustration of a cartridge including the inductive substrate of FIG. 3 according to at least one example embodiment.

In at least one example embodiment, as shown in FIG. 6, a cartridge 600 may be generally the same as the cartridge 500 as described with respect to FIG. 5 except that the cartridge 600 includes a plurality of susceptors 640 in the plug 630 of inductive substrate material, which are arranged in a plurality of rows and columns within the aerosol-generating substrate. The cartridge 600 may include 2 to 8 columns (e.g., 2 to 6 columns or 2 to 4 columns) and 2 to 10 rows of susceptors 640 (e.g., 2 to 8 rows, 2 to 6 rows or 2 to 4 rows). For example, the cartridge 600 may include 4 columns and 7 rows of susceptors 640. The rows of susceptors 640 may be spaced about 1 mm to about 7 mm apart from adjacent rows, and the columns may be spaced 1 mm to about 7 mm apart from adjacent columns. In some example embodiments, susceptors 640 of each row and/or column may be in line with susceptors 640 of one or more other rows and/or columns. In further example embodiments, susceptors 640 of each row and/or column may be offset from susceptors 640 of one or more other rows and/or columns. In at least one example embodiment, a number of susceptors 640 in each row and/or column may vary or be the same between each of the rows and/or columns of the cartridge 600.

As shown in FIG. 6, the cartridge 600 includes a first seal 610 and a second seal 620 similar to those as described with respect to FIG. 5. In at least one example embodiment, the first seal 610 and the second seal 620 are filters.

FIG. 7 is an illustration of a cartridge including the inductive substrate of FIG. 3 according to at least one example embodiment. 19.

In at least one example embodiment, as shown in FIG. 7, a cartridge 700 may be generally the same as cartridges 500 and 600 of FIGS. 5 and 6, respectively, except that instead of susceptors 740 being arranged in rows and columns, the susceptors 740 are elongate bars or rods of the susceptor material as described with respect to FIG. 3.

In at least one example embodiment, the plug 730 of inductive substrate material includes at least one elongated, rod-shaped susceptor 740. The elongated, rod-shaped susceptor 740 may have a length ranging from about 2 mm to about 20 mm (e.g., about 5 mm to about 15 mm or about 8 mm to about 12 mm). In at least one example embodiment, the susceptor 740 may extend a majority of a length of the plug 730 and/or the susceptor 740 may extend such that ends of the susceptor 740 are adjacent a first seal 710 and a second seal 720. In some example embodiments, the plug 730 includes 1 to 10 rod-shaped susceptors (e.g., about 2 to 8 or about 4 to 6).

The susceptor 740 may have a generally cylindrical cross-section. In other example embodiments, the cross-section may be square, oval, rectangular, or any other polygonal shape. Dimensions of the cross-section may range from about 2 mm thick×5 mm wide to about 10 mm thick×30 mm wide.

While not wishing to be bound by theory, the addition of the susceptors to the inductive substrate may improve the thermal uniformity inside a solid substrate, such as the carrier material. In traditional inductive heating systems, a sizeable susceptor structure in the form of a sheet or a cylinder may be required to produce the heating. This configuration may induce a considerable temperature gradient in carrier materials, such as plant-based materials, which may be poorly thermal conductive. Further, while not wishing to be bound by theory, the addition of a collection of tiny susceptors in a substrate material may minimize and/or reduce a temperature gradient in the substrate. When a consumable containing the inductive substrate is used in a heated tobacco device, heat may transfer from individual susceptors to their surroundings, so as to create multiple local heat zones, minimize and/or reduce the temperature gradient, and/or enhance the temperature uniformity. In general, if the carrier materials hold enough susceptors, the thermal uniformity may be improved.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Illustrative embodiment 1. A cartridge for use in a heated tobacco device, the cartridge comprising: an aerosol-generating substrate; and a plurality of susceptors within the aerosol-generating substrate, the plurality of susceptors configured to heat at least a portion of the aerosol-generating substrate.

Illustrative embodiment 2. The cartridge of Illustrative embodiment 1, further comprising a housing surrounding the aerosol-generating substrate, the housing formed of one or more material including a paper, tobacco, non-tobacco cellulose, a fabric, a metal, a polymer, or any combination thereof.

Illustrative embodiment 3. The cartridge of any of Illustrative embodiments 1-2, wherein the housing includes non-tobacco cellulose and the housing is impregnated with at least one flavorant.

Illustrative embodiment 4. The cartridge of any of Illustrative embodiments 1-2, wherein the housing includes non-tobacco cellulose and the housing is impregnated with nicotine.

Illustrative embodiment 5. The cartridge of Illustrative embodiment 1, wherein the aerosol-generating substrate includes a carrier material, the carrier material including a plant material.

Illustrative embodiment 6. The cartridge of any of Illustrative embodiments 1-5, wherein the plant material includes tobacco.

Illustrative embodiment 7. The cartridge of any of Illustrative embodiments 1-5, wherein the plant material includes non-tobacco cellulose.

Illustrative embodiment 8. The cartridge of any of Illustrative embodiments 1-5, wherein the plant material includes hemp.

Illustrative embodiment 9. The cartridge of any of Illustrative embodiments 1-5, wherein the plant material includes reconstituted tobacco.

Illustrative embodiment 10. The cartridge of Illustrative embodiment 1, wherein the aerosol-generating substrate comprises: a carrier material; a plurality of aerosol-generating agents within the carrier material; and a plurality of flavoring agents within carrier material.

Illustrative embodiment 11. The cartridge of any of Illustrative embodiments 1-5, wherein the plurality of flavoring agents includes a botanical material, a gel, a film, flavor bits, a powder, a compressed powder, a flavor bead, microcapsules, capsules, or any combination thereof.

Illustrative embodiment 12. The cartridge of Illustrative embodiment 1, further comprising: a first filter at a first end of the aerosol-generating substrate; and a second filter at a second end of the aerosol-generating substrate.

Illustrative embodiment 13. The cartridge of Illustrative embodiment 1, further comprising: a mouthpiece at a first end of the aerosol-generating substrate.

Illustrative embodiment 14. The cartridge of Illustrative embodiment 1, wherein a density of the plurality of susceptors within the aerosol-generating substrate is between 1.5 g/cm³ and 10 g/cm³.

Illustrative embodiment 15. The cartridge of Illustrative embodiment 1, wherein the plurality of susceptors includes a circular shape, an oval shape, a rectangular shape, a polygonal shape, or any combination thereof.

Illustrative embodiment 16. The cartridge of Illustrative embodiment 1, wherein the plurality of susceptors is uniformly disposed throughout the aerosol-generating substrate.

Illustrative embodiment 17. The cartridge of Illustrative embodiment 1, wherein the plurality of susceptors is non-uniformly disposed throughout the aerosol-generating substrate.

Illustrative embodiment 18. The cartridge of any of Illustrative embodiments 1-16, wherein the plurality of susceptors is arranged in a plurality of rows and columns within the aerosol-generating substrate.

Illustrative embodiment 19. The cartridge of Illustrative embodiment 1, wherein the plurality of susceptors includes a plurality of elongate rods.

Illustrative embodiment 20. The cartridge of Illustrative embodiment 1, wherein the plurality of susceptors comprises a material including iron, steel, stainless steel, graphite, graphene, carbon fiber, aluminum brass, copper, chrome, nickel, tungsten, silver, gold, platinum, silicon, or any combination thereof.

Illustrative embodiment 21. The cartridge of Illustrative embodiment 1, wherein a density of the plurality of susceptors in the cartridge is greater at a central portion of the aerosol-generating substrate than at edges of the aerosol-generating substrate.

Illustrative embodiment 22. A heated tobacco system, comprising: a cartridge including, an aerosol-generating substrate, and a plurality of susceptors within the aerosol-generating substrate, the plurality of susceptors configured to heat at least a portion of the aerosol-generating substrate; and a heated tobacco device including, a device housing defining a cavity configured to receive at least a portion of the cartridge, an induction source within the device housing, and a power supply configured to supply power to the induction source.

Illustrative embodiment 23. The heated tobacco system of Illustrative embodiment 22, wherein the aerosol-generating substrate comprises: a carrier material; a plurality of aerosol-generating agents within the carrier material; and a plurality of flavoring agents within the aerosol-generating substrate.

Illustrative embodiment 24. The heated tobacco system of Illustrative embodiment 22, further comprising: a first filter at a first end of the aerosol-generating substrate; and a second filter at a second end of the aerosol-generating substrate.

Illustrative embodiment 25. The heated tobacco system of Illustrative embodiment 22, further comprising: a mouthpiece at a first end of the aerosol-generating substrate.

Illustrative embodiment 26. The heated tobacco system of Illustrative embodiment 22, wherein a density of the plurality of susceptors within the aerosol-generating substrate is between 1.5 g/cm³ and 10 g/cm³.

Illustrative embodiment 27. The heated tobacco system of Illustrative embodiment 22, wherein the plurality of susceptors include a circular shape, a rectangular shape, a polygonal shape, or combination thereof.

Illustrative embodiment 28. The heated tobacco system of Illustrative embodiment 22, wherein the plurality of susceptors is uniformly disposed throughout the aerosol-generating substrate.

Illustrative embodiment 29. The heated tobacco system of any of Illustrative embodiments 22-28, wherein the plurality of susceptors is arranged in a plurality of rows and columns within the aerosol-generating substrate.

Illustrative embodiment 30. The heated tobacco system of Illustrative embodiment 22, wherein the plurality of susceptors include a plurality of elongate rods.

Illustrative embodiment 31. The heated tobacco system of Illustrative embodiment 22, wherein a density of the plurality of susceptors in the cartridge is greater at a central portion of the aerosol-generating substrate than at edges of the aerosol-generating substrate.

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

We claim:

1. A cartridge for use in a heated tobacco device, the cartridge comprising:
an aerosol-generating substrate; and
a plurality of susceptors within the aerosol-generating substrate, the plurality of susceptors configured to heat at least a portion of the aerosol-generating substrate.

2. The cartridge of claim 1, further comprising a housing surrounding the aerosol-generating substrate, the housing formed of one or more material including a paper, tobacco, non-tobacco cellulose, a fabric, a metal, a polymer, or any combination thereof.

3. The cartridge of claim 2, wherein the housing includes non-tobacco cellulose and the housing is impregnated with at least one flavorant.

4. The cartridge of claim 2, wherein the housing includes non-tobacco cellulose and the housing is impregnated with nicotine.

5. The cartridge of claim 1, wherein the aerosol-generating substrate includes a carrier material, the carrier material including a plant material.

6. The cartridge of claim 5, wherein the plant material includes tobacco, non-tobacco cellulose, hemp, or reconstituted tobacco.

7. The cartridge of claim 1, wherein the aerosol-generating substrate comprises:
a carrier material;
a plurality of aerosol-generating agents within the carrier material; and
a plurality of flavoring agents within carrier material.

8. The cartridge of claim 7, wherein the plurality of flavoring agents includes a botanical material, a gel, a film, flavor bits, a powder, a compressed powder, a flavor bead, microcapsules, capsules, or any combination thereof.

9. The cartridge of claim 1, further comprising:
a first filter at a first end of the aerosol-generating substrate; and
a second filter at a second end of the aerosol-generating substrate.

10. The cartridge of claim 1, further comprising:
a mouthpiece at a first end of the aerosol-generating substrate.

11. The cartridge of claim 1, wherein a density of the plurality of susceptors within the aerosol-generating substrate is between 1.5 g/cm³ and 10 g/cm³.

12. The cartridge of claim 1, wherein the plurality of susceptors includes a circular shape, an oval shape, a rectangular shape, a polygonal shape, or any combination thereof.

13. The cartridge of claim 1, wherein the plurality of susceptors is uniformly disposed throughout the aerosol-generating substrate.

14. The cartridge of claim 1, wherein the plurality of susceptors is non-uniformly disposed throughout the aerosol-generating substrate.

15. The cartridge of claim 13, wherein the plurality of susceptors is arranged in a plurality of rows and columns within the aerosol-generating substrate.

16. The cartridge of claim 1, wherein the plurality of susceptors includes a plurality of elongate rods.

17. The cartridge of claim 1, wherein the plurality of susceptors comprises a material including iron, steel, stainless steel, graphite, graphene, carbon fiber, aluminum brass, copper, chrome, nickel, tungsten, silver, gold, platinum, silicon, or any combination thereof.

18. The cartridge of claim 1, wherein a density of the plurality of susceptors in the cartridge is greater at a central portion of the aerosol-generating substrate than at edges of the aerosol-generating substrate.

19. A heated tobacco system, comprising:
a cartridge including,
an aerosol-generating substrate, and
a plurality of susceptors within the aerosol-generating substrate, the plurality of susceptors configured to heat at least a portion of the aerosol-generating substrate; and
a heated tobacco device including,
a device housing defining a cavity configured to receive at least a portion of the cartridge,
an induction source within the device housing, and
a power supply configured to supply power to the induction source.

20. The heated tobacco system of claim 19, wherein the aerosol-generating substrate comprises:
a carrier material;
a plurality of aerosol-generating agents within the carrier material; and
a plurality of flavoring agents within the aerosol-generating substrate.
